(19) United States
(12) Patent Application Publication
(10) Pub. No.: US 2013/0201187 A1
(43) Pub. Date: Aug. 8, 2013

(54) IMAGE-BASED MULTI-VIEW 3D FACE GENERATION

(71) Applicants: Xiaofeng Tong, Beijing (CN); Jianguo Li, Beijing (CN); Wei Hu, Beijing (CN); Yangzhou Du, Beijing (CN); Yimin Zhang, Beijing (CN)

(72) Inventors: Xiaofeng Tong, Beijing (CN); Jianguo Li, Beijing (CN); Wei Hu, Beijing (CN); Yangzhou Du, Beijing (CN); Yimin Zhang, Beijing (CN)

(21) Appl. No.: 13/522,783

(22) PCT Filed: Aug. 9, 2011
(86) PCT No.: PCT/CN11/01306

§ 371 Date: Jul. 18, 2012

(51) Int. Cl. G06T 17/00

(52) U.S. Cl. CPC G06T 17/00
USPC 345/420

(57) ABSTRACT

Systems, devices and methods are described including recovering camera parameters and sparse key points for multiple 2D facial images and applying a multi-view stereo process to generate a dense avatar mesh using the camera parameters and sparse key points. The dense avatar mesh may then be used to generate a 3D face model and multi-view texture synthesis may be applied to generate a texture image for the 3D face model.

### BACKGROUND

3D modeling of human facial features is commonly used to create realistic 3D representations of people. For instance, virtual human representations such as avatars frequently make use of such models. Conventional applications for generated 3D faces require manual labeling of feature points. While such techniques may employ morphable model fitting, it would be desirable if they permitted automatic facial landmark detection and employed Multi-view Stereo (MVS) technology.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system;

FIG. 2 illustrates an example 3D face model generation process;

FIG. 3 illustrates an example of a bounding box and identified facial landmarks;

FIG. 4 illustrates an example of multiple recovered cameras and a corresponding dense avatar mesh;

FIG. 5 illustrates an example of fusing a reconstructed morphable face mesh to a dense avatar mesh;

FIG. 6 illustrates an example morphable face mesh triangle;

FIG. 7 illustrates an example angle-weighted texture synthesis approach;

FIG. 8 illustrates an example combination of a texture image with a corresponding smoothed 3D face model to generate a final 3D face model; and

FIG. 9 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

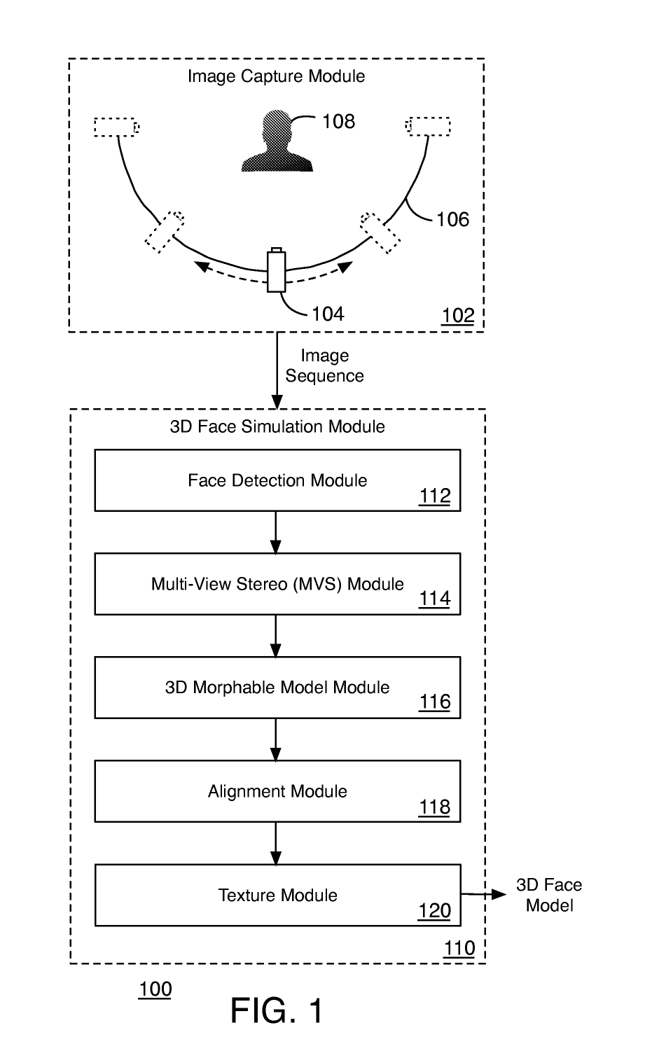

FIG. 1 illustrates an example system 100 in accordance with the present disclosure. In various implementations, system 100 may include an image capture module 102 and a 3D face simulation module 110 capable of generating a 3D face model including facial texture as will be described herein. In various implementations, system 100 may be employed in character modeling and creation, computer graphics, video conferencing, on-line gaming, virtual reality applications, and so forth. Further, system 100 may be suitable for applications such as perceptual computing, digital home entertainment, consumer electronics, and the like.

Image capture module 102 includes one or more image capturing devices 104, such as a still or video camera. In some implementations, a single camera 104 may be moved along an arc or track 106 about a subject face 108 to generate a sequence of images of face 108 where the perspective of each image with respect to face 108 is different as will be explained in greater detail below. In other implementations, multiple imaging devices 104, positioned at various angles with respect to face 108 may be employed. In general, any number of known image capturing systems and/or techniques may be employed in capture module 102 to generate image sequences (see, e.g., Seitz et al., “A Comparison and Evaluation of Multi-View Stereo Reconstruction Algorithms,” In Proc. IEEE Conf. on Computer Vision and Pattern Recognition, 2006) (hereinafter “Seitz et al.”).

Image capture module 102 may provide the image sequence to simulation module 110. Simulation module 110 includes at least a face detection module 112, a multi-view stereo (MVS) module 114, a 3D morphable face module 116, an alignment module 118, and a texture module 120, the functionality of which will be explained in greater detail below. In general, as will also be explained in greater detail below, simulation module 110 may be used to select images from among the images provided by capture module 102, perform face detection on the selected images to obtain facial bounding-boxes and facial landmarks, recover camera parameters and obtain sparse key-points, perform multi-view stereo techniques to generate a dense avatar mesh, fit the mesh to a morphable 3D face model, refine the 3D face model by aligning and smoothing it, and synthesize a texture image for the face model.

In various implementations, image capture module 102 and simulation module 110 may be adjacent to or in proximity of each other. For example, image capture module 102 may employ a video camera as imaging device 104 and simulation module 110 may be implemented by a computing system that receives an image sequence directly from device 104 and then processes the images to generate a 3D face model and texture image. In other implementations, image capture module 102 and simulation module 110 may be remote from each other. For example, one or more server computers that are remote from image capture module 102 may implement simulation module 110 where module 110 may receive image sequences from module 102 via, for example, the internet. Further, in various implementations, simulation module 110 may be provided by any combination of software, firmware and/or hardware that may or may not be distributed across various computing systems.

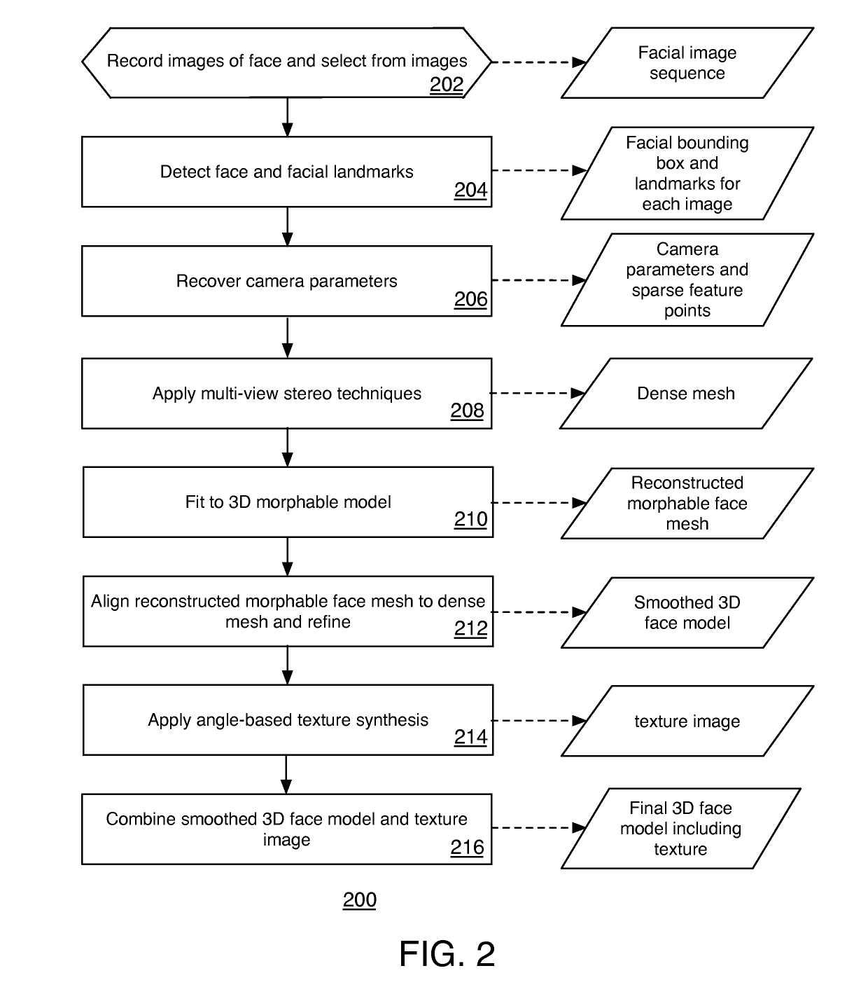

FIG. 2 illustrates a flow diagram of an example process 200 for generating a 3D face model according to various implementations of the present disclosure. Process 200 may include one or more operations, functions or actions as illustrated by one or more of blocks 202, 204, 206, 208, 210, 212, 214 and 216 of FIG. 2. By way of non-limiting example, process 200 will be described herein with reference to example system of FIG. 1. Process 200 may begin at block 202.

At block 202, multiple 2D images of a face may be captured and various ones of the images may be selected for further processing. In various implementations, block 202 may involve using a common commercial camera to record video images of a human face from different perspectives. For example, video may be recorded at different orientations spanning approximately 180 degrees around the front of a human head for a duration of about 10 seconds while the face remains still and maintains a neutral expression. This may result in approximately three hundred 2D images being captured (assuming a standard video frame rate of thirty frames per second). The resulting video may then be decoded and a subset of about 30 or so facial images may be selected either manually or by using an automated selection method (see, e.g., R. Hartley and A. Zisserman, “Multiple View Geometry in Computer Vision,” Chapter 12, Cambridge Press, Second Version (2003)). In some implementations, the angle between adjacent selected images (as measured with respect to the subject being imaged) may be 10 degrees or smaller.

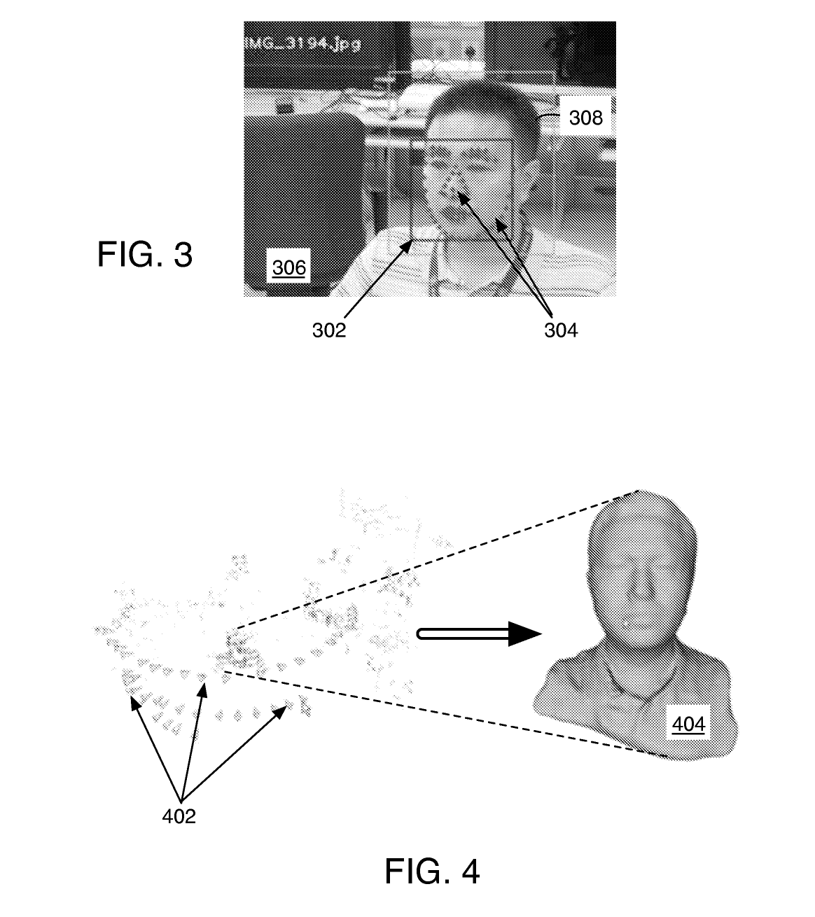

Face detection and facial landmark identification may then be performed on the selected images at block 204 to generate corresponding facial bounding boxes and identified landmarks within the bounding boxes. In various implementations, block 204 may involve applying known automated multi-view face detection techniques (see, e.g., Kim et al., “Face Tracking and Recognition with Visual Constraints in Real-World Videos”, In IEEE Conf. Computer Vision and Pattern Recognition (2008)) to outline the face contour and facial landmarks in each image using the face bounding-box to restrict the region in which landmarks are identified and to remove extraneous background image content. For instance, FIG. 3 illustrates a non-limiting example of a bounding box 302 and identified facial landmarks 304 to a 2D image 306 of a human face 308.

At block 206, camera parameters may be determined for each image. In various implementations, block 206 may include, for each image, extracting stable key-points and using known automatic camera parameter recovery techniques, such as described in Seitz et al., to obtain a sparse set of feature points and camera parameters including a camera projection matrix. In some examples, face detection module 112 of system 100 may undertake block 204 and/or block 206.

At block 208, multi-view stereo (MVS) techniques may be applied to generate a dense avatar mesh from the sparse feature points and camera parameters. In various implementations, block 208 may involve performing known stereo homography and multi-view alignment and integration techniques for facial image pairs. For example, as described in WO2010133007 (“Techniques for Rapid Stereo Reconstruction from Images”), for a pair of images, optimized image point pairs obtained by homography fitting may be triangulated with the known camera parameters to produce a three-dimensional point in a dense avatar mesh. For instance, FIG. 4 illustrates a non-limiting example of multiple recovered cameras 402 (e.g., as specified by recovered camera parameters) as may be obtained at block 206 and a corresponding dense avatar mesh 404 as may be obtained at block 208. In some examples, MVS module 114 of system 100 may undertake block 208.

Returning to the discussion of FIG. 2, the dense avatar mesh obtained at block 208 may be fitted to a 3D morphable model at block 210 to generate a reconstructed 3D morphable face mesh. The dense avatar mesh may then be aligned to the reconstructed morphable face mesh and refined at block 212 to generate a smoothed 3D face model. In some examples, 3D morphable model module 116 and alignment module 118 of system 100 may undertake blocks 210 and 212, respectively.

In various implementations, block 210 may involve learning a morphable face model from a face data set. For example, a face data set may include shape data (e.g., (x, y, z) mesh coordinates in Cartesian coordinate system) and texture data (red, green and blue color intensity values) specifying each point or vertex in the dense avatar mesh. The shape and texture may be represented by respective column vectors (x₁, y₁, z₁, x₂, y₂, z₂, . . . , xₙ, yₙ, zₙ)^{t}, and (R₁, G₁, B₁, R₂, G₂, B₂, . . . , Rₙ, Gₙ, Zₙ)^{t} (where n is the number of feature points or vertices in a face), respectively.

A generic face may be represented as a 3D morphable face model using the following formula:

$$X = {X}_{0} + {\sum }_{i = 1}^{n} {α}_{i} {U}_{i} {λ}_{i} \qquad ( 1 )$$

where X₀ is the mean column vector λᵢ is the i^{th} eigen-value, Uᵢ is the i^{th} eigen-vector, and αᵢ is the reconstructed metric coefficient of the i^{th} eigen-value. The model represented by Eqn. (1) may then be morphed into various shapes by adjusting the set of coefficients {α}ₙ.

Fitting the dense avatar mesh to the 3D morphable face model of Eqn. (1) may involve defining morphable model vertices S_{mod} analytically as

S_{mod}=P(X₀+αUλ) (2)

where PεR^{3n×3K} is a projection that selects n vertices corresponding to feature points from the complete set K of morphable model vertices. In Eqn. (2) the n feature points are used to measure the reconstructed error.

During fitting, model priors may be applied resulting in the following cost function:

E=∥P(X₀+αUλ)−S′_{rec}∥+η∥α∥ (3)

where Eqn. (3) assumes that the probability of representing a qualified shape directly depends on the norm. Larger values for a correspond to larger differences between a reconstructed face and the mean face. The parameter η trades off the prior probability and the fitting quality in Eqn. (3) and may be determined iteratively by minimizing the following cost function:

$${min}_{δ α} ( {‖ δ S - A δ α ‖}^{2} + η {‖ α + δ α ‖}^{2} ) \qquad ( 4 )$$

where δS=∥S_{mod}S′_{rec}∥ and A=PUλ. Applying a singular decomposition to A yields A=Udiag(wᵢ)V^{T} where wᵢ is the singular value of A.

Eqn. (4) may be minimized when the following condition holds:

$$δα = Vdiag ( \frac{{w}_{i}}{{w}_{i}^{2} + η} ) {U}^{T} δ S - Vdiag ( \frac{{w}_{i}}{{w}_{i}^{2} + η} ) {V}^{T} α . \qquad ( 5 )$$

Using Eqn. (5), a may be iteratively updated as α=α+δα. In addition, in some implementations η may be adjusted iteratively where η may be initially set to w₀² (e.g., the largest singular value) and may be decreased to the square of the smaller singular values.

In various implementations, given the reconstructed 3D points provided at block 210 in the form of a reconstructed morphable face mesh, alignment at block 212 may involve searching for both the pose of a face and the metric coefficients needed to minimize the distance from the reconstructed 3D point to the morphable face mesh. The pose of a face may be provided by the transform

$$T = ( \begin{matrix}sR & t \\ {0}^{T} & 1\end{matrix} )$$

from the coordinate frame of the neutral face model to that of the dense avatar mesh, where R is a 3×3 rotation matrix, t is a translation, and s is a global scale. For any 3D vector p, the notation T(p)=sRp+t may be employed.

The vertex coordinates of a face mesh in the camera frame are a function of both the metric coefficients and the face pose. Given metric coefficients {α₁, α₂, . . . , αₙ} and pose T, the face geometry in the camera frame may be provided by

$$S = T ( {X}_{0} + {\sum }_{i = 1}^{n} {α}_{i} {U}_{i} {λ}_{i} ) . \qquad ( 6 )$$

In examples where the face mesh is a triangular mesh, any point on the triangle may be expressed as a linear combination of the three triangle vertexes measured in barycentric coordinates. Thus, any point on a triangle may be expressed as a function of T and the metric coefficients. Furthermore, when T is fixed, it may be represented as a linear function of the metric coefficients described herein.

The pose T and the metric coefficients {α₁, α₂, . . . , αₙ} may then be obtained by minimizing

$$E = {\sum }_{i = 1}^{n} {d}^{2} ( {p}_{i} , S ) \qquad ( 7 )$$

where (p₁, p₂, . . . , pₙ) represent the points of the reconstructed face mesh, and d(pᵢ, S) represents the distance from a point pᵢ to the face mesh S. Eqn. (7) may be solved using an iterative closed point (ICP) approach. For instance, at each iteration, T may be fixed and, for each point pᵢ, the closest point gᵢ on the current face mesh S may be identified. The error E may then be minimized (Eqn. (7)) and the reconstructed metric coefficients obtained using Eqns. (1)-(5). The face pose T may then be found by fixing the metric coefficients {α₁, α₂, . . . , αₙ}. In various implementations this may involve building a kd-tree for the dense avatar mesh points, searching the closed points in dense point for the morphable face model, and using least squares techniques to obtain the pose transform T. The ICP may continue with further iterations until the error E has converged and the reconstructed metric coefficients and pose T are stable.

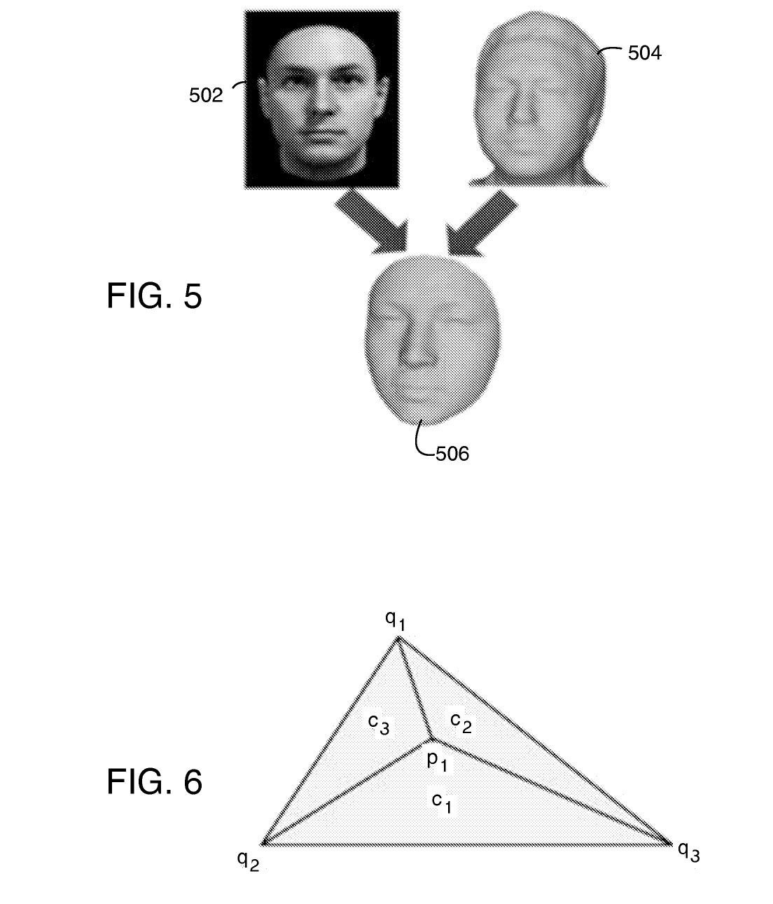

Having aligned the dense avatar mesh (obtained from MVS processing at block 208) and the reconstructed morphable face mesh (obtained at block 210), the results may be refined or smoothed by fusing the dense avatar mesh to the reconstructed morphable face mesh. For instance, FIG. 5 illustrates a non-limiting example of fusing a reconstructed morphable face mesh 502 to a dense avatar mesh 504 to obtain a smoothed 3D face model 506.

In various implementations, smoothing the 3D face model may include creating a cylindrical plane around the face mesh, and unwrapping both the morphable face model and the dense avatar mesh to the plane. For each vertex of the dense avatar mesh, a triangle of the morphable face mesh may be identified that includes the vertex, and the barycentric coordinates of the vertex within the triangle may be found. A refined point may then be generated as a weighted combination of the dense point and corresponding points in the morphable face mesh. The refinement of a point pᵢ in dense avatar mesh may be provided by:

$${p}_{i} = \frac{( α {p}_{i} + β ( {c}_{1}^{i} \cdot {q}_{1}^{i} + {c}_{2}^{i} \cdot {q}_{2}^{i} + {c}_{3}^{i} \cdot {q}_{3}^{i} ) )}{( α + β )} \qquad ( 8 )$$

where α and β are weights, (q₁, q₂, q₃) are the three vertices of the morphable face mesh triangle containing the point pᵢ, and (c₁, c₂, c₃) is the normalized area of the three sub-triangles as illustrated in FIG. 6. In various implementations, at least portions of block 212 may be undertaken by alignment module 118 of system 100.

After generation of the smoothed 3D face mesh at block 212, the camera projection matrix may be used to synthesize a corresponding face texture by applying multi-view texture synthesis at block 214. In various implementations, block 214 may involve determining a final face texture (e.g., a texture image) using an angle-weighted texture synthesis approach where, for each point or triangle in the dense avatar mesh, projected points or triangles in the various 2D facial images may be obtained using a corresponding projection matrix.

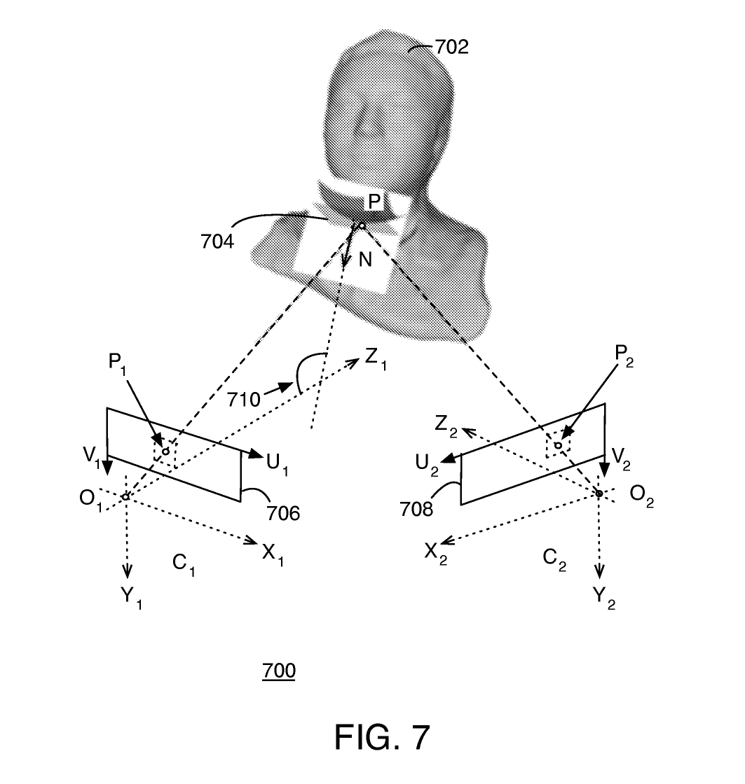

FIG. 7 illustrates an example angle-weighted texture synthesis approach 700 that may be applied at block 214 in accordance with the present disclosure. In various implementations, block 214 may involve, for each triangle of the dense avatar mesh, taking a weighted combination of the texture data of all of the projected triangles obtained from the sequence of facial images. As shown in the example of FIG. 7, a 3D point P associated with a triangle in dense avatar mesh 702 and having a normal N defined with respect to the surface of a plane 704 tangential to the mesh 702 at point P, may be projected towards two example cameras C₁ and C₂ (having respective camera centers O₁ and O₂) resulting in 2D projection points P₁ and P₂ in the respective facial images 706 and 708 captured by cameras C₁ and C₂.

Texture values for points P₁ and P₂ may then be weighted by the cosine of the angle between the normal N and the principle axis of the respective cameras. For instance, the texture value of point P₁ may be weighted by the cosine of the angle 710 formed between the normal N and the principle axis Z₁ of camera C₁. Similarly, although not shown in FIG. 7 in the interest of clarity, the texture value of point P₂ may be weighted by the cosine of the angle formed between the normal N and the principle axis Z₂ of camera C₂. Similar determinations may be made for all cameras in the image sequence and the combined weighted texture values may be used to generate a texture value for point P and its associated triangle. Block 214 may involve undertaking similar process for all points in the dense avatar mesh to generate a texture image corresponding to the smoothed 3D face model generated at block 212. In various implementations, block 214 may be undertaken by texture module 120 of system 100.

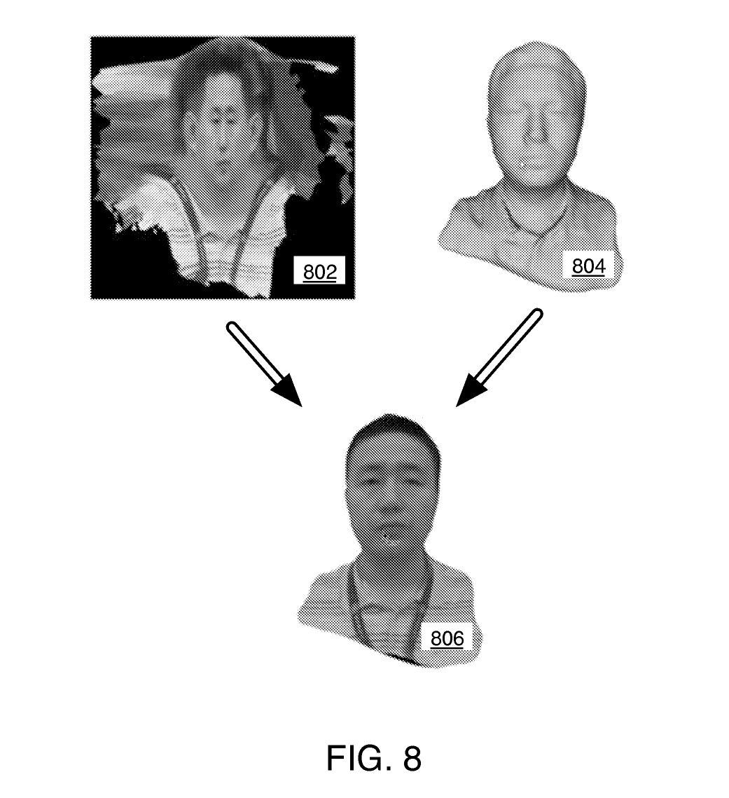

Process 200 may conclude at block 216 where the smoothed 3D face model and the corresponding texture image may be combined using known techniques to generate a final 3D face model. For instance, FIG. 8 illustrates an example of a texture image 802 being combined with a corresponding smoothed 3D face model 804 to generate a final 3D face model 806. In various implementations, the final face model may be provided in any standard 3D data format (such as .ply, .obj, and so forth).

While the implementation of example process 200 as illustrated in FIG. 2 may include the undertaking of all blocks shown in the order illustrated, the present disclosure is not limited in this regard and, in various examples, implementation of process 200 may include the undertaking only a subset of all blocks shown and/or in a different order than illustrated. In addition, any one or more of the blocks of FIG. 2 may be undertaken in response to instructions provided by one or more computer program products. Such program products may include signal bearing media providing instructions that, when executed by, for example, one or more processor cores, may provide the functionality described herein. The computer program products may be provided in any form of computer readable medium. Thus, for example, a processor including one or more processor core(s) may undertake or be configured to undertake one or more of the blocks shown in FIG. 2 in response to instructions conveyed to the processor by a computer readable medium.

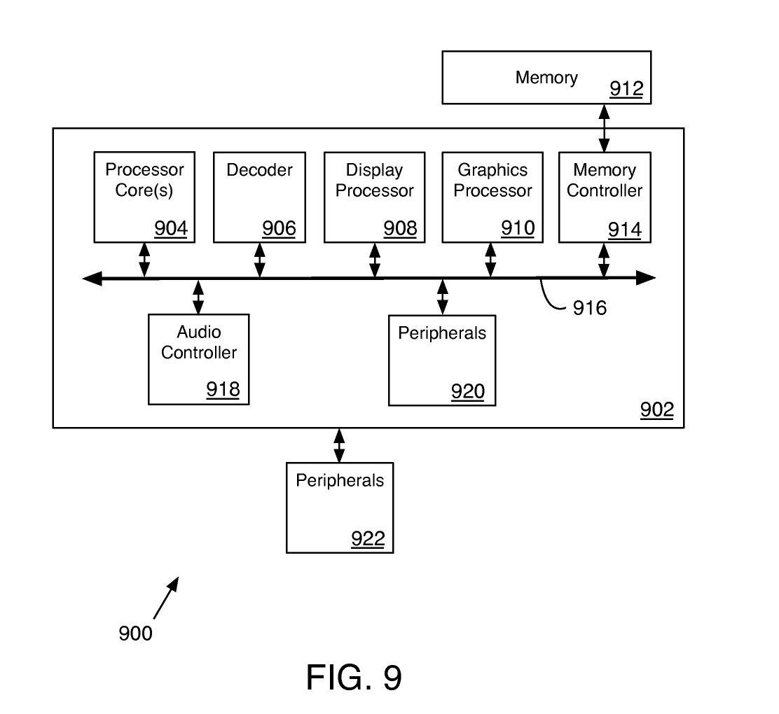

FIG. 9 illustrates an example system 900 in accordance with the present disclosure. System 900 may be used to perform some or all of the various functions discussed herein and may include any device or collection of devices capable of undertaking image-based multi-view 3D face generation in accordance with various implementations of the present disclosure. For example, system 900 may include selected components of a computing platform or device such as a desktop, mobile or tablet computer, a smart phone, a set top box, etc., although the present disclosure is not limited in this regard. In some implementations, system 900 may be a computing platform or SoC based on Intel® architecture (IA) for CE devices. It will be readily appreciated by one of skill in the art that the implementations described herein can be used with alternative processing systems without departure from the scope of the present disclosure.

System 900 includes a processor 902 having one or more processor cores 904. Processor cores 904 may be any type of processor logic capable at least in part of executing software and/or processing data signals. In various examples, processor cores 904 may include CISC processor cores, RISC microprocessor cores, VLIW microprocessor cores, and/or any number of processor cores implementing any combination of instruction sets, or any other processor devices, such as a digital signal processor or microcontroller.

Processor 902 also includes a decoder 906 that may be used for decoding instructions received by, e.g., a display processor 908 and/or a graphics processor 910, into control signals and/or microcode entry points. While illustrated in system 900 as components distinct from core(s) 904, those of skill in the art may recognize that one or more of core(s) 904 may implement decoder 906, display processor 908 and/or graphics processor 910. In some implementations, processor 902 may be configured to undertake any of the processes described herein including the example process described with respect to FIG. 2. Further, in response to control signals and/or microcode entry points, decoder 906, display processor 908 and/or graphics processor 910 may perform corresponding operations.

Processing core(s) 904, decoder 906, display processor 908 and/or graphics processor 910 may be communicatively and/or operably coupled through a system interconnect 916 with each other and/or with various other system devices, which may include but are not limited to, for example, a memory controller 914, an audio controller 918 and/or peripherals 920. Peripherals 920 may include, for example, a unified serial bus (USB) host port, a Peripheral Component Interconnect (PCI) Express port, a Serial Peripheral Interface (SPI) interface, an expansion bus, and/or other peripherals. While FIG. 9 illustrates memory controller 914 as being coupled to decoder 906 and the processors 908 and 910 by interconnect 916, in various implementations, memory controller 914 may be directly coupled to decoder 906, display processor 908 and/or graphics processor 910.

In some implementations, system 900 may communicate with various I/O devices not shown in FIG. 9 via an I/O bus (also not shown). Such I/O devices may include but are not limited to, for example, a universal asynchronous receiver/transmitter (UART) device, a USB device, an I/O expansion interface or other I/O devices. In various implementations, system 900 may represent at least portions of a system for undertaking mobile, network and/or wireless communications.

System 900 may further include memory 912. Memory 912 may be one or more discrete memory components such as a dynamic random access memory (DRAM) device, a static random access memory (SRAM) device, flash memory device, or other memory devices. While FIG. 9 illustrates memory 912 as being external to processor 902, in various implementations, memory 912 may be internal to processor 902. Memory 912 may store instructions and/or data represented by data signals that may be executed by processor 902 in undertaking any of the processes described herein including the example process described with respect to FIG. 2. For example, memory 912 may store data representing camera parameters, 2D facial images, dense avatar meshes, 3D face models and so forth as described herein. In some implementations, memory 912 may include a system memory portion and a display memory portion.

The devices and/or systems described herein, such as example system 100 represent several of many possible device configurations, architectures or systems in accordance with the present disclosure. Numerous variations of systems such as variations of example system 100 are possible consistent with the present disclosure.

The systems described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed:

1. A computer-implemented method, comprising:
receiving a plurality of 2D facial images;
recovering camera parameters and sparse key points from the plurality of facial images;
applying a multi-view stereo process to generate a dense avatar mesh in response to the camera parameters and sparse key points;
fitting the dense avatar mesh to generate a 3D face model; and
applying multi-view texture synthesis to generate a texture image associated with the 3D face model.

2. The method of claim 1, further comprising performing facial detection on each facial image.

3. The method of claim 2, wherein performing facial detection on each facial image comprises automatically generating a facial bounding box and automatically identifying facial landmarks for each image.

4. The method of claim 1, wherein fitting the dense avatar mesh to generate the 3D face model comprises:
fitting the dense avatar mesh to generate a reconstructed morphable face mesh; and
aligning the dense avatar mesh to the reconstructed morphable face mesh to generate the 3D face model.

5. The method of claim 4, wherein fitting the dense avatar mesh to generate the reconstructed morphable face mesh comprises applying an iterative closed point technique.

6. The method of claim 4, further comprises refining the 3D face model to generate a smoothed 3D face model.

7. The method of claim 6, further comprising combining the smoothed 3D model with the texture image to generate a final 3D face model.

8. The method of claim 1, wherein recovering camera parameters includes recovering a camera position associated with each facial image, each camera position having a main axis, and wherein applying multi-view texture synthesis comprises:
generating, for a point in the dense avatar mesh, a projected point in each facial image;
determining a value of the cosine of an angle between a normal of the point in the dense avatar mesh and the main axis of each camera position; and
generating a texture value for the point in the dense avatar mesh as a function of texture values of the projected points weighted by the corresponding cosine values.

9. A system, comprising:
a processor and a memory coupled to the processor, wherein instructions in the memory configure the processor to:
receive a plurality of 2D facial images;
recover camera parameters and sparse key points from the plurality of facial images;
apply a multi-view stereo process to generate a dense avatar mesh in response to the camera parameters and sparse key points;
fit the dense avatar mesh to generate a 3D face model; and
apply multi-view texture synthesis to generate a texture image associated with the 3D face model.

10. The system of claim 9, wherein instructions in the memory further configure the processor to perform facial detection on each facial image.

11. The system of claim 10, wherein performing facial detection on each facial image comprises automatically generating a facial bounding box and automatically identifying facial landmarks for each image.

12. The system of claim 9, wherein fitting the dense avatar mesh to generate the 3D face model comprises:
fitting the dense avatar mesh to generate a reconstructed morphable face mesh; and
aligning the dense avatar mesh to the reconstructed morphable face mesh to generate the 3D face model.

13. The system of claim 12, wherein fitting the dense avatar mesh to generate the reconstructed morphable face mesh comprises applying an iterative closed point technique.

14. The system of claim 9, wherein recovering camera parameters includes recovering a camera position associated with each facial image, each camera position having a main axis, and wherein applying multi-view texture synthesis comprises:
generating, for a point in the dense avatar mesh, a projected point in each facial image;
determining a value of the cosine of an angle between a normal of the point in the dense avatar mesh and the main axis of each camera position; and
generating a texture value for the point in the dense avatar mesh as a function of texture values of the projected points weighted by the corresponding cosine values.

15. An article comprising a computer program product having stored therein instructions that, if executed, result in:
receiving a plurality of 2D facial images;
recovering camera parameters and sparse key points from the plurality of facial images;
applying a multi-view stereo process to generate a dense avatar mesh in response to the camera parameters and sparse key points;
fitting the dense avatar mesh to generate a 3D face model; and
applying multi-view texture synthesis to generate a texture image associated with the 3D face model.

16. The article of claim 15, the computer program product having stored therein further instructions that, if executed, result in performing facial detection on each facial image.

17. The article of claim 16, wherein performing facial detection on each facial image comprises automatically generating a facial bounding box and automatically identifying facial landmarks for each image.

18. The article of claim 15, wherein fitting the dense avatar mesh to generate the 3D face model comprises:
fitting the dense avatar mesh to generate a reconstructed morphable face mesh; and
aligning the dense avatar mesh to the reconstructed morphable face mesh to generate the 3D face model.

19. The article of claim 18, wherein fitting the dense avatar mesh to generate the reconstructed morphable face mesh comprises applying an iterative closed point technique.

20. The article of claim 15, wherein recovering camera parameters includes recovering a camera position associated with each facial image, each camera position having a main axis, and wherein applying multi-view texture synthesis comprises:
generating, for a point in the dense avatar mesh, a projected point in each facial image;
determining a value of the cosine of an angle between a normal of the point in the dense avatar mesh and the main axis of each camera position; and
generating a texture value for the point in the dense avatar mesh as a function of texture values of the projected points weighted by the corresponding cosine values.
